(19) United States
(12) Patent Application Publication
(10) Pub. No.: US 2004/0102112 A1
(43) Pub. Date: May 27, 2004

(54) Flame-retardant nonwovens

(76) Inventors: Sheri L. McGuire, O'Fallon, MO (US); Thomas E. Taylor, Charlotte, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/714,370

(22) Filed: Nov. 14, 2003

Related U.S. Application Data
(63) Continuation-in-part of application No. 10/298,990, filed on Nov. 18, 2002.

(51) Int. Cl. B32B 3/00; B32B 5/02

(52) U.S. Cl. 442/59

(57) ABSTRACT

The present invention relates to a nonwoven fabric which is capable of passing the California Technical Bulletin 603 testing when the nonwoven article is employed in a mattress. The nonwoven fabric/article of the present invention may be produced from a combination of low melt binders, and synthetic and/or natural fiber. The low melt binder may be bicomponent fiber, low melting fiber, or latex resin. Additionally, the nonwoven article may have one or more fibers that are coated with FR resin. The present invention relates to a nonwoven article produced from about 6 to about 25 weight % of low melt binder; synthetic fiber and/or natural fiber that is coated with an FR resin material, and optionally other non coated, non-FR natural or non-FR synthetic fiber.

### CROSS REFERENCE TO RELATED APPLICATION

This application is a Continuation-In-Part of my co-pending U.S. patent application Ser. No. 10/298,990, filed Nov. 18, 2002.

### BACKGROUND OF THE INVENTION

1) Field of the Invention

The present invention concerns an improved flame-retardant (FR) nonwoven fabric that can be employed in many applications, particularly as barrier layers between exterior fabric and the inner stuffing of furniture, comforters, pillows, and mattresses. The nonwoven fabric comprises from about 6 to 25 weight % of a low melt binder (a bicomponent fiber, a latex resin, or a low-melting fiber); fiber coated with an FR resin coating; and uncoated natural or synthetic fibers. Said coated fiber can likewise be synthetic and/or natural fibers. Another embodiment of the present invention is a nonwoven fabric comprising from about 6 to 25 weight % of a low melt binder, inherent FR fiber, and other synthetic and/or natural fibers. Yet another embodiment of the present invention is the combination of a low melt binder with an FR resin in nonwoven compositions. Nonwoven fabric prepared from these components, possessing a batt weight of greater than about 5 ounces per square yard, is capable of passing stringent flame-resistant tests for both commercial and particularly for residential mattresses.

2) Prior Art

Flame-retardant or flame-resistant materials (FR) are well known to those skilled in the textile art. Such materialscan be woven or nonwoven, knitted, or laminates with other materials such that they pass various textile flame-resistant or flame-retardant tests such as California TB117 and TB 133 for upholstery; NFPA701 for curtains and drapes; California Test Bulletin 129 dated. October 1992 concerning flammability test procedures for mattresses in public buildings, and California Test Bulletin 603 concerning mattresses for residential use. The last 2 tests are the most stringent tests for mattresses known in the U.S.A.

Various FR fibers are well known to those skilled in the art. FR fibers based on polyester, rayon, nylon, acrylic, melamine, and polyolefin fibers such as polyethylene, or polypropylene fibers, are well known and commercially available.

U.S. Pat. No. 6,214,058 issued to Kent et al. on Apr. 10, 2001 describes fabrics made from melamine fibers that may or may not be flame-resistant fabrics. This reference describes a process for dying melamine fabrics including blends of melamine and natural fibers (such as wool or cotton) or other synthetic fibers such as rayon or polyester. As a passing comment it mentions that melamine fiber may be FR.

U.S. Pat. No. 6,297,178 issued to Berbner et al. on Oct. 2, 2001 discloses flame-proof fabrics made of FR melamine fibers and FR rayon fibers. The melamine and rayon fibers and made FR by coating the fibers with aluminum.

U.S. Patent Application Publication 2003/0021978 issued to Wolf discloses a cotton, PET (polyethylene terephthalate), boric acid admixture made into a nonwoven useful in mattresses, futons, and pillows.

PCT application WO 03/023108 filed Sep. 11, 2002 in the name of Mater and Handermann discloses a highloft FR material composed of FR rayon or FR melamine that are inherently FR. Additionally the application also discloses and requires the use of modacrylic fibers. These materials have no coating thereon.

In spite of the above-mentioned patents and patent application, and numerous other nonwoven FR fabrics, there is still a need in the industry to create inexpensive nonwoven FR articles that pass the stringent guidelines of California Test Bulletin 129 as well as 603. Moreover, there is a need in the industry to produce such a nonwoven article from materials that are relatively inexpensive and have light batt weights.

Generally, the California Technical Bulletin 129 (for mattresses used in public) states that the mattress must char but not burn through for a minimum of 3 minutes based on certain conditions such as the position of the flame, temperature of the flame, the source of the flame being used, etc. Moreover, after one hour (57 minutes after the flame source has been extinguished) of burning, the test is terminated and certain conditions must be met as more fully set forth herein. California technical Bulletin 603 (for residential mattresses) states that a specific pair of propane test burners are placed on the top panel and border of the mattress/foundation set. The burners are ignited and left to burn for 70 seconds (top) and 50 seconds (border). After both burners are out, the mattress burning continues until either all combustion is ceased, the Total Heat Release in first 10 mins does not exceed 25MJ, 30 mins. has passed, the maximum rate of heat release=200 KW or greater, or the development of the fire is such size as to require suspension for the safety of the facility.

### SUMMARY OF THE INVENTION

The present invention relates to a nonwoven fabric which is capable of passing the California Technical Bulletin 603 testing when the nonwoven article is employed in a mattress. The nonwoven fabric/article of the present invention may be produced from a combination of low melt binder and synthetic or natural fiber. The low melt binder may be bicomponent fiber, a latex resin, or low melting fiber.

In the broadest sense, the present invention relates to a nonwoven article produced from about 6 to about 25 weight % of low melt binder; synthetic fiber and/or natural fiber that are coated with an FR resin material, and uncoated natural or synthetic fiber.

In the broadest sense, the present invention also relates to a nonwoven article produced from about 6 to about. 25 weight % of low melt binder, inherent FR fiber, and other natural or synthetic fiber.

In the broadest sense, the present invention also relates to a nonwoven article produced from about 6 to about 25 weight % of a combination of a low melt binder and an FR resin, and other natural or synthetic fiber.

### DESCRIPTION OF THE PREFERRED EMBODIMENTS

The nonwoven article of the present invention is produced from materials generally known to those skilled in the art, however, before the present invention those materials have not been assembled into a nonwoven article like that of the present invention.

Suitable FR fibers are those that can pass the Various tests set forth below, FR fibers having too little flame-resistance are not suitable for the present invention. Sufficient amounts of FR fibers must be present if the nonwoven article is to pass the California Test Bulletin 129 and 603 tests.

The FR fibers employed in the nonwoven articles of the present invention may be an inherent flame resistant fiber or an FR fiber (natural or synthetic fibers) that are coated with an FR resin. An inherently flame resistant fiber may be one whose polymeric structure incorporates an FR component such as phosphorus or phosphorus compounds, an amine, modified aluminosilicate, or halogen based compounds. An especially preferred halogen based compound is a thermoplastic polyvinyl halide composition. Thermoplastic polyvinyl halide compositions, when exposed to a flame, generate oxygen depleting gases which help to extinguish the flame. Thus it is inherently flame resistant. Modacrylic fiber is a generic name for a synthetic manufactured copolymer fiber composed of between about 35 wt. % and 85 wt. % of acrylonitrile units (—CH₂CH(CN)—), with the remainder being vinyl chloride or vinylidene chloride monomers. Suitable modacrylic fibers are sold under the trade name of Modacrylic™ distributed by Mitsui Textile Corporation, Protex sold by Kaneka, or SEF Plus by Solutia, Inc. These modacrylic fibers are copolymers of acrylonitrile and vinyl chloride or vinylidene chloride. Other inherently flame resistant fibers are: a) rayon with aluminosilicate modified with silica and sold by Sateri Oy in Finland under the trademark Visil® fiber; b) a melamine fiber sold under the trademark Basofil® fiber, and polyester (PET) with phosphalane (organo phosphorus compound) such as that sold under the trademark Trevira CS® fiber or Avora® Plus by KoSa. These inherent flame resistant fibers are not coated, but have an FR component incorporated within the synthetic material (within its structural chemistry).

The natural or synthetic fibers coated with an FR resin contain one or more of the same type components mentioned above, namely phosphorus, phosphorus compound(s), red phosphorus, esters of phosphorus, and phosphorus complexes; amine compounds, boric acid, bromide, urea-formaldehyde compound(s), phosphate-urea compound(s), ammonium sulphate, or halogen based compounds. The typical FR resin is clear or translucent latex and is applied by spraying or dipping (saturation). Other non-clear FR resins are also known and are employed where color is not important. A suitable commercially available FR resin is sold under the trade name Guardex FR, or FFR which is produced by Glotex Chemicals in Spartanburg, S.C. While there are several different varieties of Guardex and Glotex FR resins, those skilled in the art can pick and choose among them to find that which is most compatible, taking into account such things as cost, appearance, smell, and the affect it may have on other fibers in the nonwoven batt (does it make the other fibers rough, or have a soft hand, or discolor the other fibers, etc.). FR resin may be applied to specific fibers in a range from about 6 to 25 weight % of the weight of the specific fibers or the nonwoven article. Although the FR resin may be in liquid form, the amount of add-on is always on a dry wt. Basis. The FR resin could be applied to natural or synthetic fibers before they are dry laid/air laid onto a conveyor belt. It is also within the scope of the present invention to purchase the fiber already coated with the desired FR resin coating, and merely blend them into the nonwoven fabric. Non-resin coatings like metallic coating are not suitable for the present invention, because they tend to flake-off after continuous use of the product.

Nonwoven batts are typically held in position by means of a binder. The binder may be a low-melt fiber, a bicomponent fiber, or a spray-on or dip applied latex binder. It is also within the scope of the present invention to make the FR resin have binding characteristics. In this regard, for example, an FR resin may simply be blended with a latex binder, particularly halogenated latex binder such as PVA (polyvinyl acetate) or acrylic latex, and simply sprayed-on the nonwoven batt.

Some Guardex FR products are only FR resin latex having no significant binding effect. These types generally can be cured at about 300° F., or preferably lower to minimize yellow discoloration. Other nonbinding types can be cured at room temperature, although this is usually not commercially feasible (it lowers production). The nonbinding types merely cured to the fibers themselves so that it provides an FR characteristic to the fiber in addition to any FR characteristics, or lack thereof, of the fibers that are used in the nonwoven batt.

Other Guardex FR resins products have binding characteristics and are also cured with heat at about the same temperatures mentioned above. Generally these types of FR resins with binding characteristics have the major component as the binder and a minor amount is FR resin. For example, Guardex products with binding functions are about 60 to 90 wt. % binder latex and the remainder is FR resin latex. The above FR product (Guardex) is typically a liquid product applied as a spray or by dipping. Other FR resins are in solid form may be applied as a hot melt product to the fibers, or as a solid powder which is then melted onto the fibers. When the FR resin is also a binder, it may be desirable to provide additional binders to more firmly lock the fibers in place. For example an FR resin with additional low melt binders are within the scope of the present invention.

As mentioned previously, the binder may be low melt fiber, bicomponent fiber, or a latex resin (that is typically sprayed or dipped). The low melt binder is generally employed in a range of from about 6 to 25 weight % of the nonwoven batt. The low melt binder melts or liquefies at a temperature lower than the remaining components of the nonwoven article, and preferably at least 5° F. lower than any remaining component in the nonwoven.

When the binder is bicomponent fiber, it contains a low melt portion and a high melt portion. Consequently, the bicomponent fiber may be either the side-by-side type where the low melt component is adjacent to the high melt component, or the sheath-core type wherein the high melt is the core and low melt component forms the sheath. Such bicomponent fibers are well known to those skilled in the art and may be based upon polyolefin/polyester, copolyester/polyester, polyester/polyester, polyolefin/polyolefin, wherein the naming convention is the low melt component followed by the high melt component. In those types wherein it is polyester/polyester, or polyolefin/polyolefin the high melt component has at least 5 and preferably 8° F. higher melting temperature than the low melting temperature. More specifically, for example, a polyolefin/polyolefin could be polyethylene polypropylene. Suitable bicomponent fibers are preferably a 50/50 low melt to high melt portion. But the present invention also contemplates a broader range of the low melt component to the high melt component of 20:80 to 80:20 for the bicomponent fiber.

When the binder is a low melt polymer fiber, those fibers mentioned above with respect to the low melt component of the bicomponent fiber are also suitable low melt polymer fibers. In other words, the low melt polymer fiber may be copolyester, or polyolefin, such as polyethylene. Lastly, when the binder is a latex resin, it has a low melt temperature so that once the latex is sprayed on the nonwoven fiber batt, it can be cured by drying or heating (subjecting the nonwoven batt to an oven for a short period of time sufficient to cure the latex). Such low melt binders are well known to those skilled in the art.

Suitable synthetic fibers compatible with FR resin are polyester, such as polyethylene terephthalate (PET), polybutylene terephthalate, polypropylene terephthalate, among others; rayon, nylon such as nylon 6 and nylon 6,6; polyolefin such as polyethylene and polypropylene, among others; and acrylic fiber. Blends of two or more of the above fibers are also contemplated. Preferred synthetic fibers are PET and rayon.

Suitable natural fibers compatible with FR resin are flax, kenaf, hemp, cotton, wool, silk and blends of these. Preferred natural fiber is cotton.

Suitable non-FR synthetic fibers may be polyester, rayon, nylon, polyolefin, acrylic, copolymers of any of these, and combinations of these. When non-FR synthetic fibers are employed, they provide certain characteristics like loft, resiliency (springiness), tensile strength, and thermal retention, all of which are useful properties for household goods. Preferable non-FR synthetic fibers are those made from PET and rayon fibers.

Natural fibers may also be employed in the nonwoven batts of the present invention. Natural fibers such as flax, kenaf, hemp, cotton, silk, and wool may be employed, depending on the properties desired. A blend of two or more of these is also within the scope of the invention. Preferred is cotton.

Because the non-FR synthetic fibers and natural fibers are nonbinding and are not flame-resistant, such fibers can be used to dial in desired characteristics and cost. As such it is also within the scope of the invention to employ a mixture of synthetic and natural fibers.

For mattresses employed in public buildings, such as hotels and motels, the state of California, Department of Consumer Affairs, Bureau of Home Furnishings and Thermal Insulation, have issued Technical Bulletin 129. The purpose of this test is to set a standard for the behavior of mattresses used in public occupancy such as the above hotels and motels mentioned, and dormitories for universities, health care facilities, etc. Specifically, this test measures the mattress when it is subject to a specific flame ignition source under well-ventilated conditions. Under such conditions, a flame is applied initially for 3 minutes. The mattress continues to burn and fails to meet the requirements of The California Burn Test 129 if any of the following criteria are exceeded:

1. Weight loss due to combustion of 3 lbs. or greater in the first 10 minutes

2. A maximum rate of heat release of 100 kW or greater

3. A total heat release of 25MJ or greater in the first 10 minutes

The California Test Bulletin 603 applies to residential mattresses. This test utilizes a pair of propane burners, designed to mimic the heat flux levels and durations imposed on a residential mattress and foundation by burning bedclothes. The test specimen cannot exceed 200 kilowatts of heat released during the 30 minute test period and cannot exceed 25 MJ of the total heat release in the first 10 minutes of the test.

To conduct the TB 603 testing, the specific pair of propane test burners is placed on the top panel and border of the mattress/foundation set. The burners are ignited and left to burn for 70 seconds (top) and 50 seconds (border). After both burners are out, the mattress burning continues until either all combustion is ceased, 30 minutes has passed, criteria for 200 KW heat release or 25MJ is exceeded, or the development of the fire is such size as to require suspension for the safety of the facility.

The nonwoven batt may be constructed as follows. The various combination of fibers employed in the present invention can be weighed and then dry laid/air laid onto a moving conveyor belt, for example. The size or thickness of a nonwoven batt is generally 9. measured in terms of ounces per square yard. The speed of the conveyor belt for example can determine or provide the desired batt weight. If a thick batt is required, then the conveyor belt moves slower than for a thin batt. The weight % of the total fibers in the batt is 100%. This includes the weight of the FR resin on the fiber. It also includes the bicomponent fiber or low melt polymer fiber employed as a binder. If the fibers are not purchased with the FR resin applied, then the fiber may be coated with an FR resin. The amount of FR resin applied is generally in the range of 6 to 25 wt. % of the fiber to be coated (6 to 25 wt. % add-on).

Suitable nonwoven fabrics of the present invention have a batt weight greater than about 5 ounces per square yard. Preferably the batt weight ranges from 5 ounces per square yard to 20 ounces per square yard with the most preferred range being 6 to 9 ounces per square yard. Using a batt weight greater than about 20 ounces per square yard offers no significant improvement in performance and is more costly. Using a batt weight less than about 5 ounces per square yard generally does not provide sufficient protection (i.e. char strength) to the underlying mattress, for example, or the furniture, etc.

In continuing with the description of the construction, if any rearrangement of the fibers is desired, such as by carding, this occurs next. Then the conveyor belt moves to an area where any spray-on binder is added to the nonwoven batt, or the conveyor belt is immersed in the liquid binder while the batt remains positioned on a conveyor belt. If the conveyor belt is foraminous, once the batt is removed from the area, the excessive binder drips through the belt and may be collected for later reuse. Alternatively, one may buy the natural or synthetic fibers already coated with an FR resin. Under this alternative approach, it is not necessary for the conveyor belt to traverse through a spray or dip area.

Next the conveyor belt moves the nonwoven dry laid batt to an oven for melting and curing the low melt component of the bicomponent fiber or the low melt polymer fiber or resin binder. Residence time in the oven depends on the fibers employed and is easily determinable by one skilled in the art. Naturally, those skilled in the art know to use only sufficient residence time to melt the low melt component, at a temperature and time that does not degrade the synthetic and/or natural fibers that make up the nonwoven batt. Thereafter, the nonwoven batt is cooled so that any low melt binder material resolidifies thus locking the fibers employed into a solid batt. Thereafter, the batt may be cut to any size desired to serve as mattress fabric or other purposes such as stuffing for comforters, pillows and furniture. It may also be wound onto rolls and shipped to a customer who may cut the batt into the desired length.

### General Procedures

Various nonwoven batts made from synthetic or natural fibers with and without an FR coating, have a range of dpf (denier per filament) between 1.5 and 10 as previously mentioned. The nonwoven batts were tested utilizing a bench scale test developed by Western Nonwovens: a sample of nonwoven fabric is completely wrapped a single time around a 6″×2″ piece of foam. A meika burner is placed 2-3″ from the bottomside of the (foam & fabric) sample and ignited. (This is a vertical flame check). The flame should come into direct contact with the fabric and stay in contact with the fabric for at least 10 minutes. It is important (by visual observation) that the barrier fabric maintains structural integrity and does not allow the flame to come into contact with the foam.

Some of the nonwoven batts were taken a step further and employed in specimens and tested under TB 603. The specimens consisted of a twin size, inner spring mattress and foundation set. Each specimen was covered with a white/off white colored ticking material. The twin mattress was a one-sided pillow top mattress, which is one of the more stringent mattress configurations for test compliance.

Each test specimen, after conditioning to 73° F. and 50% relative humidity was placed on a steel frame. The specified propane burners were placed as required and set forth in TB 603. The computer data acquisition system was started and the burners were ignited and allowed to burn for 70 seconds (top) & 50 seconds (border). The test was continued until either all combustion ceased, or 30 minutes had passed, or the maximum rate of heat release of 200 KW was exceeded or the total heat release of 25MJ was exceeded in first 10 minutes.

For the following examples, the cotton fibers were purchased from Leigh Fibers in Spartanburg, S.C. The low melt binder was a bicomponent binder purchased from Unitika. It was a 50% sheath of polyethylene terephthalate isophthalate, and a 50% core of PET. The modacrylic fiber was purchased from Mitsui. The rayon was purchased from Lenzing. In each example, the total weight of all fibers is 100%. Therefore, if the binder is a fiber, it is also included in the total. On the other hand, if the binder is applied as a spray or by dipping, it is described as % add-on to all the fiber or a specific portion of the fibers.

### EXAMPLE 1

A nonwoven batt comprising 15% by weight Modacrylic, Protex S, at 7 dpf was blended with 15% by weight of a low melt binder, 40% by weight cotton and 30% by weight (6 dpf) PET was made. The cotton was pretreated with an FR resin (Glotex-Glotard FFR FR resin coating) at an add-on weight of 15%. The PET was produced by Wellman. The batt weight was 9 oz./yd².

The nonwoven batt had a bench scale burn time of 1200+seconds (the test was terminated because it had more than passed the minimum requirement of 600 seconds (10 minutes) for this test). A mattress was also made from the nonwoven batt according to the specifications required by California TB 603. The twin 1-sided pillow top mattress was tested according to TB 603. It passed the full-scale test. The results are set forth in Table 1.

### EXAMPLE 2

A nonwoven batt was made by blending 30% by weight treated rayon with 20% low melt fiber, 30% Modacrylic, Protex S at 7 dpf, and 20-weight % PET at 6 dpf. The rayon was pretreated with the FR resin described in Example 1 at a 15% add-on weight. The batt weight was 9 oz./yd². The bench scale burn test was 600+ minutes (the burn time was terminated because it had more than passed the test). A twin one-sided pillow top mattress, made in accordance with California TB 603, was tested and it passed the full-scale test. The PET was produced by Sam Yang. The results are set forth in Table 1.

### EXAMPLE 3

In Example 3, 30% FR rayon as set forth in Example 2 was mixed with 15% of low melt binder, 30% by weight of Modacrylic, Protex S, at 7 dpf, and 25 weight % PET at 6 dpf from Sam Yang. The entire batt was coated with the FR resin specified in Example 1 at an add-on of 15% by weight. No bench scale burn time test was completed on this sample and it was not produced in mattress form. The batt weight was 6.75 oz./yd².

### EXAMPLE 4

A nonwoven batt comprising 30 wt. % FR treated rayon from Lenzing, as set forth in Example 2, was constructed with 30 wt. % Modacrylic, Protex S at 7 dpf, and 40 wt. % PET, 6 dpf from Sam Yang was made. The entire batt was spray coated with 15 wt. % add-on of a combination FR resin and binder from Glotex-Glotard FFR. About 10% by weight of the spray coating was binder and the remainder (about 5 wt. %) was FR resin. The batt weight was 6.75 oz./yd². The nonwoven batt had a benchscale burn time of 600 seconds plus. No full-scale TB 603 test was completed on this nonwoven construction. The results are set forth in Table 1.

### EXAMPLE 5

A nonwoven batt comprising 50 wt % treated rayon from Lenzing, 20 wt. % low-melt, and 30 wt. % PET from Sam Yang (6 dpf) was made. The rayon was previously coated with 15 wt. % add-on FR resin from Glotex-Glotard FFR. The batt weight was 11.25 oz./yd². The nonwoven batt had a bench scale burn time of 600 seconds plus. No full-scale TB 603 test was completed on this nonwoven construction. The results are set forth in Table 1.

### EXAMPLE 6

A nonwoven batt comprising 50 wt. % Visil® rayon from Sateri Oy, 20 wt. % low melt, and 30 wt. % PET from Sam Yang (6 dpf) was made. The batt weight was 11.25 oz./yd². The nonwoven batt had a bench scale burn time of 600 seconds plus: No full-scale TB 603 test was completed on this nonwoven construction. The results are set forth in Table 1.

### EXAMPLE 7

A nonwoven batt comprising 40 wt. % Visil® rayon from Sateri Oy, 20 wt. % low melt, and 40 wt. % Pet from. Sam Yang (6 dpf) was made. The entire batt was spray coated with 20 wt. % add-on FR resin from Glotex-Glotard FFR. The batt weight was 6.75 oz./yd². The nonwoven batt had a benchscale burn time of 600 seconds plus. No full-scale TB 603 test was completed on this nonwoven construction. The results are set forth in Table 1.

### EXAMPLE 8

A nonwoven batt comprising 40 wt. % Visil® rayon from Sateri Oy, 15 wt. % low melt, 15 wt. % Pet from Sam Yang (6 dpf), and 15 wt. % inherent FR PET from KoSa was made. The batt weight was 11.25 oz./yd². The nonwoven batt had a bench scale burn time of 600 seconds plus. A twin one-sided pillow top mattress, constructed in accordance with California TB 603, was tested and it passed the full-scale test. The results are set forth in Table 1.

### EXAMPLE 9

A nonwoven batt comprising 40 wt. % treated rayon, 15 wt. % low melt, 15 wt. % Pet, and 15 wt. % inherent FR PET was made. The rayon was previously coated with 15 wt. % add-on FR resin from Glotex-Glotard FFR. The batt weight was 11.25 oz./yd².

TABLE 1

| | | | | | Low-melt | | |
|---|---|---|---|---|---|---|---|
| | PET | Modacrylic | Rayon | Cotton | Binder | FR Resin | Burntime |
| Example | wt. % | wt. % | wt. % | wt. % | wt. % | wt. % | secs. |
| 1 | 30 | 15 | | 40 | 15 | 15 on | 1200+ |
| | | | | | | cotton | passed |
| | | | | | | | TB603 |
| 2 | 20 | 30 | 30 | | 20 | 15 on | 600+ passed |
| | | | | | | rayon | TB603 |
| 3 | 25 | 30 | 30 | | 15 | 15 on | No test data |
| | | | | | | rayon + | available |
| | | | | | | 15% more | |
| | | | | | | on all | |
| | | | | | | fibers | |
| 4 | 40 | 30 | 30 | | 15 on all; | 15 rayon | no test data |
| | | | | | combo | | available |
| | | | | | binder | | |
| | | | | | and FR | | |
| | | | | | resin | | |
| | | | | | (sprayed | | |
| | | | | | on) | | |
| 5 | 30 | | 50 | | 20 | 15 on | 600+ |
| | | | | | | rayon | |
| 6 | 30 | | 50 | | 20 | | 600+ |
| | | | Visil | | | | |
| 7 | 40 | | 40 | | 20 | 20 on all | not tested |
| | | | Visil | | | | |
| 8 | 30 FR | | 40 | | 15 | | 600+ |
| | PET/ | | Visil | | | | |
| | 15 | | | | | | |
| | PET | | | | | | |
| 9 | 30 FR | | 40 | | 15 | | data not |
| | PET/ | | | | | | available |
| | 15 | | | | | | |
| | PET | | | | | | |

Thus, it is apparent that there has been provided, in accordance with the invention, a nonwoven fabric that fully satisfies the objects, aims, and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the invention.

What is claimed is:

1) A nonwoven article comprising from about 6 to about 25 wt. % of low melt binder, synthetic and/or natural fiber coated with an FR resin material, and uncoated synthetic and/or natural fiber.

2) The nonwoven article of claim 1, wherein said FR resin material contains phosphorus, phosphorus compound(s), red phosphorus, esters of phosphorus, and phosphorus complexes; amine compounds, boric acid, bromide, urea-formaldehyde compound(s), phosphate-urea compound(s), ammonium sulphate, or halogen based compounds.

3) The nonwoven article of claim 1, wherein said uncoated synthetic fiber is selected from the class of rayon, polyester, nylon, polyolefin, acrylic, and combinations of two or more of these.

4) The nonwoven article of claim 3, wherein said synthetic fiber is inherent FR rayon.

5) The nonwoven article of claim 3, wherein said synthetic fiber; is inherent FR polyester.

6) The nonwoven article of claim 1, wherein said uncoated natural fiber is selected from the class of flax, kenaf, hemp, cotton, wool, silk, and combinations of two or more of these.

7) The nonwoven article of claim 1, wherein said low melt binder is a bicomponent fiber, a low melt poly er fiber, or a latex resin.

8) The nonwoven article of claim 1, wherein said synthetic and/or natural fiber coated with an FR resin material comprises from about 25 to about 75 wt. % of said article.

9) The nonwoven article of claim 1, wherein said uncoated synthetic and/or natural fiber comprises from about 20 to about 70 wt. % of said article.

10) The nonwoven article of claim 1, wherein said low melt binder is a bicomponent fiber, said coated natural fiber is cotton, and said uncoated synthetic fiber is a blend of PET and modacrylic fibers.

11) The nonwoven article of claim 10, wherein said bicomponent fiber is 15 wt % of said article, said cotton is 40 wt. % of said article, said PET is 30 wt. % of said article, and said modacrylic is 15 wt. % of said article.

12) The nonwoven article of claim 1, wherein said low melt binder is a bicomponent fiber, said coated synthetic fiber is rayon, and said uncoated synthetic fiber is a blend of PET and modacrylic fibers.

13) The nonwoven article of claim 12, wherein said bicomponent fiber is 20 wt % of said article said rayon is 30 wt. % of said article, said PET is −20 wt. % of said article, and said modacrylic is 30 wt. % of said article.

14) The nonwoven article of claim 12, wherein said bicomponent fiber is 15 wt % of said article, said rayon is 30 wt. % of said article, said PET is 25 wt. % of said article, and said modacrylic is 30 wt. % of said article.

15) The nonwoven article of claim 1, wherein said low melt binder is bicomponent fiber, said FR coated synthetic fiber is rayon, and said uncoated synthetic fiber is PET.

16) The nonwoven article of claim 15, wherein said bicomponent fiber is 20 wt. % of said article, said FR rayon fiber is 50 wt. % of said article, and said uncoated PET fiber is 30 wt. % of said article.

17) The nonwoven article of claim 15, wherein said bicomponent fiber is 15 wt. % of said article, said FR rayon fiber is 40 wt. % of said article, said uncoated PET fiber is 15 wt. % of said article.

18) A nonwoven article comprising: from about 6 to about 25 wt. % of low melt binder, inherent FR fiber, and other synthetic and/or natural fiber.

19) The nonwoven article of claim 18, wherein said inherent FR fiber incorporates phosphorus or phosphorus compounds, an amine, modified aluminosilicate, or halogen based compounds.

20) The nonwoven article of claim 18, wherein said other synthetic fiber is selected from the class of rayon, polyester, nylon, polyolefin, acrylic, and combinations of two or more of these.

21) The nonwoven article of claim 18, wherein said other natural fiber is selected from the class of flax, kenaf, hemp, cotton, wool, silk, and combinations of two or more of these.

22) The nonwoven article of claim 18, wherein said low melt binder is a bicomponent fiber, a low melt polymer fiber, or a latex resin.

23) The nonwoven article of claim 18, wherein said low melt binder is bicomponent fiber, said inherent FR fiber is rayon, polyester, or both; and said other synthetic fiber is polyester.

24) The nonwoven article of claim 23, wherein said inherent FR fiber is rayon, and said other synthetic fiber is PET.

25) The nonwoven article of claim 24, wherein said bicomponent fiber is 20 wt. % of said article, said rayon is 50 wt. % of said article, and said PET is 30 wt. % of said article.

26) The nonwoven article of claim 24, wherein said bicomponent fiber is 20 wt. % of said article, said rayon is 40 wt. % of said article, and said PET is 40 wt. % of said article.

27) The nonwoven article of claim 23, wherein said bicomponent fiber is 15 wt. % of said article, said inherent FR fiber is both 40 wt. % rayon and 30 wt. % polyester, and said other synthetic fiber is 15 wt. % PET.

28) The nonwoven article of claim 23, wherein said bicomponent fiber is 15 wt. % of said article, said inherent FR fiber is 30 wt. % PET, said polyester is 15 wt. %, and additionally comprising 40 wt. % FR coated rayon.

29) A nonwoven article comprising: a combination low melt binder and FR resin, FR coated synthetic or natural fiber, and other synthetic or natural fiber.

30) The nonwoven article of claim 29, wherein said FR coated synthetic fiber is rayon, and said other synthetic fiber is modacrylic and polyester.

31) The nonwoven article of claim 30, wherein said combination low melt binder and FR resin comprises 15 wt. % add-on of said FR coated synthetic or natural fiber, and other synthetic or natural fiber.

32) The nonwoven article of claim 30, wherein said rayon is 30 wt. % of said article, said modacrylic is 30 wt. % of said article, and said polyester is 30 wt. % of said article.
